(19) United States
(12) Patent Application Publication
(10) Pub. No.: US 2021/0356736 A1
(43) Pub. Date: Nov. 18, 2021

(54) SCANNING ASSEMBLY AND RANGING DEVICE

(71) Applicant: SZ DJI TECHNOLOGY CO., LTD., Shenzhen (CN)

(72) Inventors: Huai HUANG, Shenzhen (CN); Peng BIN, Shenzhen (CN)

(21) Appl. No.: 17/391,413

(22) Filed: Aug. 2, 2021

Related U.S. Application Data
(63) Continuation of application No. PCT/CN2019/074620, filed on Feb. 2, 2019.

(51) Int. Cl. G02B 26/10; G01S 7/481; G01S 17/10

(52) U.S. Cl. CPC G02B 26/10; G01S 17/10; G01S 7/4817; G01S 7/4814

(57) ABSTRACT

A scanning assembly includes a driver and a lens mounted at the driver. The lens is configured to collimate a light beam incident from one side of the lens, and the driver is configured to drive the lens to rotate around a rotation axis that is spaced apart from an optical axis of the lens.

### CROSS-REFERENCE TO RELATED APPLICATION

This application is a continuation of International Application No. PCT/CN2019/074620, filed Feb. 2, 2019, the entire content of which is incorporated herein by reference.

### TECHNICAL FIELD

The present disclosure relates to the technical field of laser ranging and, more particularly, to a scanning assembly and a ranging device.

### BACKGROUND

Lidar is usually equipped with a collimation lens and a plurality of prisms, in which the collimation lens is configured to collimate laser, and the plurality of prisms are configured to change propagation direction of the laser. Purpose of transmitting the laser in scanning range or receiving the laser in scanning range can be achieved by rotating the plurality of prisms. However, an overall size of the lidar is large due to arrangement of the lens and the plurality of prisms, which is not conducive to miniaturization of the lidar.

### SUMMARY

In accordance with the disclosure, there is provided a scanning assembly including a driver and a lens mounted at the driver. The lens is configured to collimate a light beam incident from one side of the lens, and the driver is configured to drive the lens to rotate around a rotation axis that is spaced apart from an optical axis of the lens.

Also in accordance with the disclosure, there is provided a ranging device including a scanning assembly and a ranging assembly. The scanning assembly includes a driver and a lens mounted at the driver. The lens is configured to collimate a light beam incident from one side of the lens, and the driver is configured to drive the lens to rotate around a rotation axis that is spaced apart from an optical axis of the lens. The ranging assembly includes a light source configured to emit a laser pulse sequence, and a central axis of a light beam emitted by the light source is spaced apart from the optical axis.

### BRIEF DESCRIPTION OF THE DRAWINGS

FIG. 1 is a perspective view of a scanning assembly according to an embodiment of the present disclosure.

FIG. 2 is a cross-sectional view of a scanning assembly according to an embodiment of the present disclosure.

FIG. 3 is a schematic diagram showing light paths of a first lens of a scanning assembly according to an embodiment of the present disclosure.

FIG. 4 is a schematic diagram showing scanning range of a first lens of a scanning assembly according to an embodiment of the present disclosure.

FIG. 5 is a schematic diagram showing light paths of a first lens of a scanning assembly according to another embodiment of the present disclosure.

FIG. 6 is a schematic diagram showing scanning range of a first lens of a scanning assembly according to another embodiment of the present disclosure.

FIG. 7 is a partial cross-sectional view of a scanning assembly according to an embodiment of the present disclosure.

FIG. 8 is a perspective view of a first rotor of a scanning assembly according to an embodiment of the present disclosure.

FIG. 9 is another perspective view of a first rotor of a scanning assembly according to an embodiment of the present disclosure.

FIG. 10 is a cross-sectional view of a scanning assembly according to another embodiment of the present disclosure.

FIG. 11 is a cross-sectional view of a scanning assembly according to another embodiment of the present disclosure.

FIG. 12 is a cross-sectional view of a scanning assembly according to another embodiment of the present disclosure.

FIG. 13 is a partial cross-sectional view of a scanning assembly according to an embodiment of the present disclosure.

FIG. 14 is a schematic diagram showing light paths of a scanning assembly according to an embodiment of the present disclosure.

FIG. 15 is a schematic diagram showing scanning range of laser emitted by a scanning assembly according to an embodiment of the present disclosure.

FIG. 16 is a cross-sectional view of a scanning assembly according to another embodiment of the present disclosure.

FIG. 17 is a cross-sectional view of a scanning assembly according to another embodiment of the present disclosure.

FIG. 18 is a schematic diagram showing ranging principle of a ranging device according to an embodiment of the present disclosure.

FIG. 19 is a circuit diagram of a ranging assembly of a ranging device according to an embodiment of the present disclosure.

FIG. 20 is another schematic diagram showing ranging principle of a ranging device according to an embodiment of the present disclosure.

FIG. 21 is a plan view of a mobile platform according to an embodiment of the present disclosure.

### DETAILED DESCRIPTION OF THE EMBODIMENTS

The embodiments of the present disclosure are described in detail below. Examples of the embodiments are shown in the accompanying drawings, where the same or similar reference numerals indicate the same or similar elements or elements with the same or similar functions. The following embodiments described with reference to the accompanying drawings are exemplary, and are only used to explain the present disclosure, and should not be understood as a limitation to the present disclosure.

In the description of the present disclosure, it should be understood that the terms “center,” “longitudinal,” “transverse,” “length,” “width,” “thickness,” “upper,” “lower,” “front,” “back,” “left,” “right,” “vertical,” “horizontal,” “top,” “bottom,” “inner,” “outer,” “clockwise,” “counterclockwise,” and other directions or positional relationships are based on the orientation or positional relationship shown in the drawings, are only for the convenience of describing the application and simplifying the description, and do not indicate or imply that the device or element referred to must have a specific orientation, be constructed, and operated in a specific orientation. Therefore, they cannot be understood as a restriction on the present disclosure. In addition, the terms “first” and “second” are only used for descriptive purposes, and should not be understood as indicating or implying relative importance or implicitly indicating the number of indicated technical features. Therefore, the features defined with “first” and “second” may explicitly or implicitly include one or more of the features. In the description of the present disclosure, “multiple” or “plurality of” means two or more than two, unless otherwise specifically defined.

In the description of the present disclosure, it should be noted that the terms “mounting,” “connection,” and “coupling” should be interpreted broadly unless otherwise clearly specified and limited. For example, it can be a fixed connection, a detachable connection, or an integrated connection. It can be a mechanical connection or an electrical connection. It can be direct connection, or indirect connection through an intermediate medium, and it can be a communication between two elements or an interaction relationship between two elements. For those of ordinary skill in the art, the specific meanings of the above terms in the present disclosure can be understood according to specific circumstances.

In the present disclosure, unless expressly stipulated and defined otherwise, the first feature being “on” or “under” the second feature may include the first and second features being in direct contact, or may include the first and second features not being in direct contact but through other features between them. Moreover, the first feature being “above,” “over,” and “on” the second feature include the first feature being directly above and obliquely above the second feature, or it simply means that the level of the first feature is higher than the second feature. The first feature being “below,” “under,” or “beneath” the second feature includes the first feature being directly below or obliquely below the second feature, or it simply means that the level of the first feature is lower than the second feature.

The following disclosure provides many different embodiments or examples to realize different structures of the present disclosure. In order to simplify the disclosure of the present disclosure, components and settings of the examples are described below. Of course, they are only examples and are not intended to limit the present disclosure. In addition, the present disclosure may repeat reference numerals and/or reference letters in different examples. Such repetition is for the purpose of simplification and clarity, and does not indicate the relationship between the various embodiments and/or settings discussed. In addition, the present disclosure provides examples of various processes and materials, but those of ordinary skill in the art may be aware of the application of other processes and/or the use of other materials.

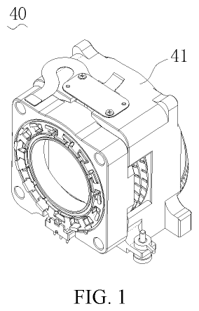

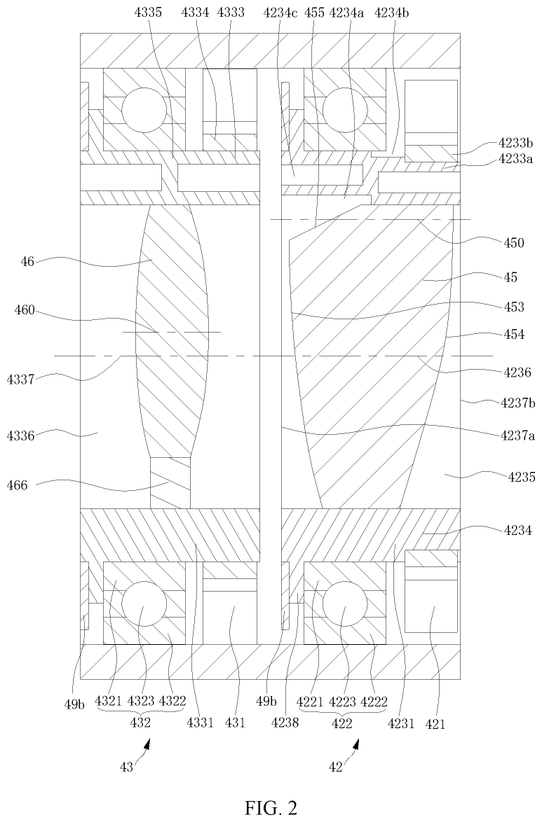

Referring to FIGS. 1 and 2, the embodiments of the present disclosure provide a scanning assembly 40 (“scanner” or “scanner assembly”) including a first lens 45 and a first driver 42. The first lens 45 is configured to collimate light beams incident from one side of the first lens 45, and the first lens 45 is mounted at the first driver 42. The first driver 42 drives the first lens 45 to rotate around a first rotation axis 4236, and a first optical axis 450 of the first lens 45 is spaced apart from the first rotation axis 4236.

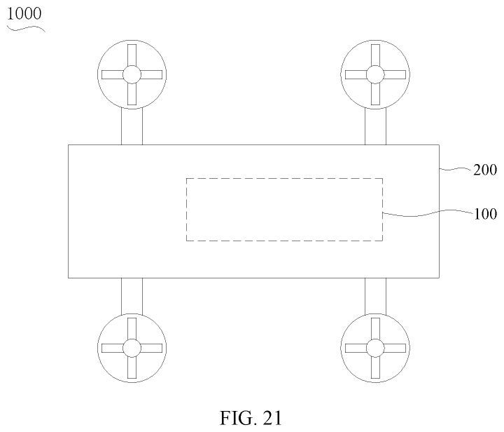

In the scanning assembly 40 of the present disclosure, the first optical axis 450 of the first lens 45 is spaced apart from the first rotation axis 4236 of the first driver 42, so that the first lens 45 can achieve an effect of deflecting laser while collimating the laser, which can reduce number of arranged prisms. That is, number of parts of the scanning assembly 40 and size of the scanning assembly 40 can be reduced, which is conducive to miniaturization of a ranging device 100 (as shown in FIG. 21).

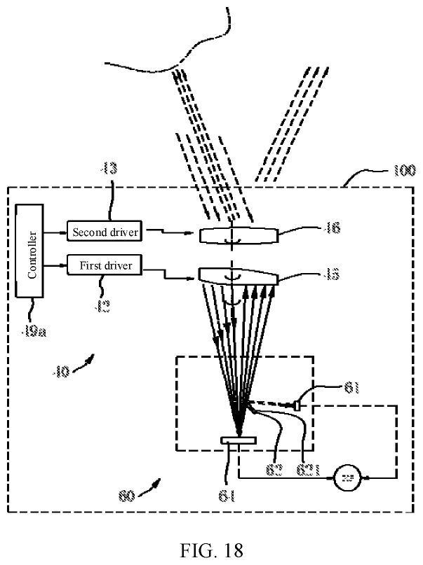

Referring to FIGS. 1 and 18, the ranging device 100 includes the scanning assembly 40 and a ranging assembly 60. The ranging assembly 60 is configured to emit a laser pulse to the scanning assembly 40, and the scanning assembly 40 is configured to change transmission direction of the laser pulse and then emit the laser pulse. The laser pulse reflected by a to-be-detected object (“object to be detected,” “detection target object,” or simply “target object”) passes through the scanning assembly 40 and then enters the ranging assembly 60, and the ranging assembly 60 is configured to determine distance between the to-be-detected object and the ranging device 100 (as shown in FIG. 21) according to the reflected laser pulse. The ranging device 100 can detect the distance between the to-be-detected object and the ranging device 100 by measuring time of light propagation, that is, time-of-flight (TOF), between the ranging device 100 and the to-be-detected object. The ranging device can also detect the distance between the to-be-detected object and the ranging device 100 by other techniques, such as a ranging method based on phase shift measurement or a ranging method based on frequency shift measurement, which is not limited herein.

Referring to FIGS. 1, 2 and 18, the scanning assembly 40 includes a scanner housing 41, the first driver 42, a second driver 43, the first lens 45, a light refraction element 46, a controller 49a, and a detector 49b. The first driver 42 is configured to drive the first lens 45 to move, so as to change the transmission direction of the laser pulse passing through the first lens 45. The second driver 43 is configured to drive the light refraction element 46 to move, so as to change the transmission direction of the laser pulse passing through the light refraction element 46. The first driver 42 and the second driver 43 can drive optical elements (the first lens 45 and the light refraction element 46) to rotate, vibrate, move cyclically along a predetermined trajectory, or move back and forth along a predetermined trajectory. The two optical elements (the first lens 45 and the light refraction element 46) cooperate with each other, and can be configured to change propagation direction of light path and enable the scanning assembly 40 to have a larger field of view.

The scanner housing 41 can be used as a housing of the scanning assembly 40, and the scanner housing 41 can be configured to house elements such as the first driver 42, the second driver 43, the first lens 45, the light refraction element 46, the controller 49a, and the detector 49b. The scanner housing 41 may be an integral whole structure, or may be formed by a plurality of sub structures.

Referring to FIG. 2, the first driver 42 includes a first stator 421, a positioning bearing 422, and a first rotor 4231. The first stator 421 is fixed within the scanner housing 41, and the first stator 421 is sleeved on the first rotor 4231 and is configured to drive the first rotor 4231 to rotate. The first stator 421 includes a first winding body and a first winding mounted at the first winding body, where the first winding body may be a stator core, and the first winding may be a coil. The first winding can generate a specific magnetic field under action of current, and direction and intensity of the magnetic field can be changed by changing direction and intensity of the current.

An axis about which the first rotor 4231 rotates relative to the first stator 421 is referred to as the first rotation axis 4236. It can be understood that the first rotation axis 4236 can be a physical rotation axis or a virtual rotation axis. The first rotor 4231 includes a first yoke 4233a and a first magnet 4233b, and the first magnet 4233b is sleeved on the first yoke 4233a and is located between the first yoke 4233a and the first winding. Magnetic field generated by the first magnet 4233b interacts with the magnetic field generated by the first winding and generates a force. Since the first winding is fixed, the first magnet 4233b drives the first yoke 4233a to rotate under the force.

The first rotor 4231 has a hollow shape. A hollow portion of the first rotor 4231 is formed with a first receiving cavity 4235, and the laser pulse can pass through the first receiving cavity 4235 and pass through the scanning assembly 40. Specifically, the first receiving cavity 4235 is surrounded by a side wall 4234 of the first rotor 4231. More specifically, in some embodiments, the first yoke 4233a may have a hollow cylindrical shape, and a hollow portion of the first yoke 4233a is formed with the first receiving cavity 4235, and a side wall of the first yoke 4233a can be used as a side wall enclosing the first receiving cavity 4235. Of course, in some other embodiments, the first receiving cavity 4235 may not be formed at the first yoke 4233a, but at a structure such as the first magnet 4233b, and the side wall 4234 may also be a side wall of a structure such as the first magnet 4233b, which are not limited herein. The side wall 4234 has a ring structure or is a part of a ring structure.

The positioning bearing 422 is located at an outer surface of the side wall 4234 of the first rotor 4231, and the positioning bearing 422 is configured to restrict the first rotor 4231 to rotate around the fixed first rotation axis 4236. The positioning bearing 422 and the first stator 421 surround the outer surface of the side wall 4234 of the first rotor 4231 side by side. The positioning bearing 422 includes a first inner ring structure 4221, a first outer ring structure 4222, and a first rolling body 4223. The first inner ring structure 4221 and the outer surface of the side wall 4234 of the first rotor 4231 are fixed to each other, and the first outer ring structure 4222 and the scanner housing 41 are fixed to each other. The first rolling body 4223 is located between the first inner ring structure 4221 and the first outer ring structure 4222, and the first rolling body 4223 is configured to rolling connect with the first outer ring structure 4222 and the first inner ring structure 4221, respectively.

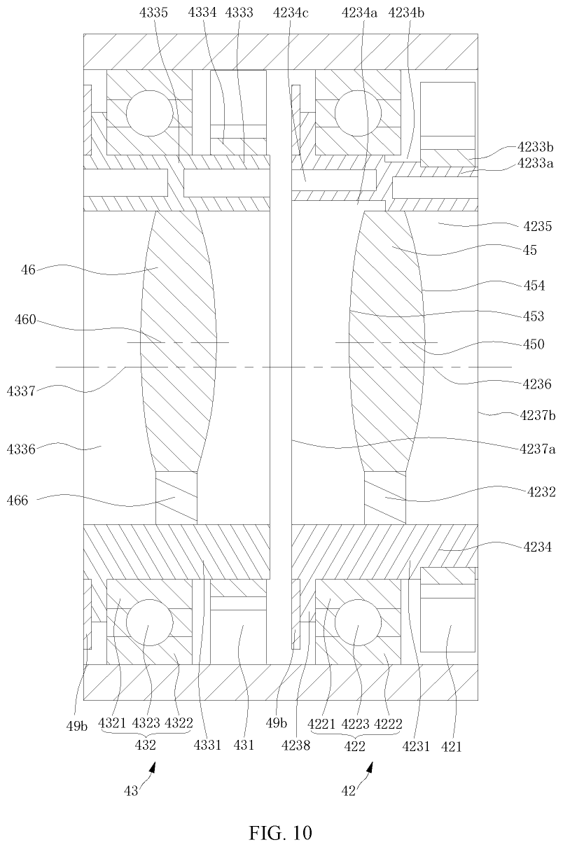

The first lens 45 may be a convex lens, such as any of a plano-convex lens, a biconvex lens, and a concave-convex lens. In some embodiments, the first lens 45 may be a complete revolution body formed with the first optical axis 450 as the center of rotation, as shown in FIGS. 10-12. In some other embodiments, the first lens 45 may also be a part of a revolution body formed with the first optical axis 450 as the center of rotation, as shown in FIGS. 2, 16, and 17. It can be understood that whether the first lens 45 is a complete revolution body can be set according to size of diaphragm (not shown in figures). For example, when radial size of the diaphragm is smaller than radial size of the first lens 45, the first lens 45 may be an incomplete revolution body; when the radial size of the diaphragm is greater than the radial size of the first lens 45, the first lens 45 may be a complete revolution body, so that the first lens 45 can adapt to diaphragms of different sizes.

Referring to FIG. 2, the first lens 45 is mounted within the first receiving cavity 4235 and is located on emission and incident light path of the laser pulse. The first lens 45 includes a first surface 453 and a second surface 454 that are arranged opposite to each other. When the laser pulse is emitted, the second surface 454 can be a light incident surface of the first lens 45, and the first surface 453 can be a light emission surface of the first lens 45. The first lens 45 is mounted in cooperation with the side wall 4234 of the first rotor 4231 and is fixedly connected to the first rotor 4231. The first optical axis 450 of the first lens 45 is parallel to and spaced apart from the first rotation axis 4236 of the first rotor 4231, and the first lens 45 and the first rotor 4231 can rotate around the first rotation axis 4236 synchronously. When the first lens 45 rotates, transmission direction of the laser passing through the first lens 45 can be changed. As such, the first lens 45 can achieve the effect of deflecting laser while collimating the laser, which can reduce the number of arranged prisms. That is, the number of parts of the scanning assembly 40 and the size of the scanning assembly 40 can be reduced.

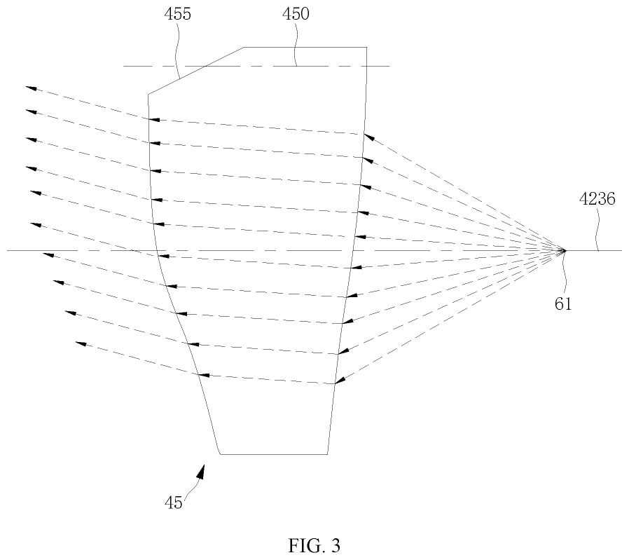

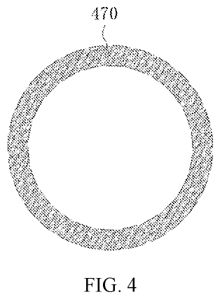

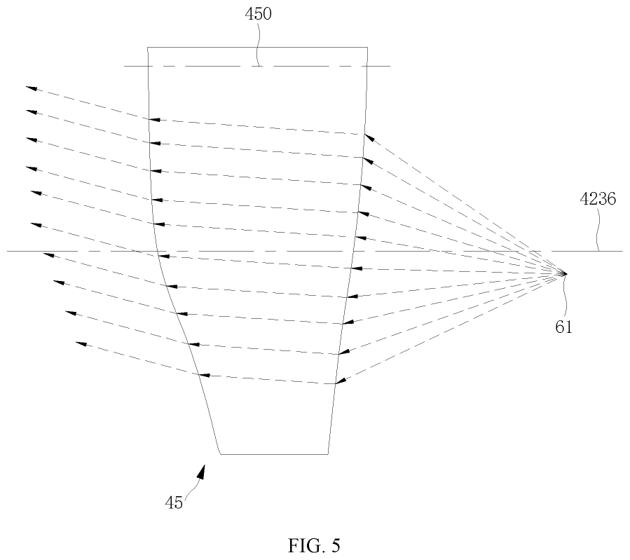

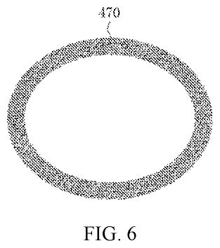

Referring to FIGS. 3-6, since the first optical axis 450 of the first lens 45 does not coincide with the first rotation axis 4236 of the first rotor 4231, when the first rotor 4231 rotates at a high speed, laser spots emitted by the first lens 45 form a circular or elliptical scanning range 470. In some embodiments, when a light source 61 is arranged at the first rotation axis 4236, the laser spots emitted by the first lens 45 form a circular scanning range 470, as shown in FIGS. 3 and 4. In some other embodiments, when the light source 61 is offset from the first rotation axis 4236, the laser spots emitted by the first lens 45 form an elliptical scanning range 470, as shown in FIGS. 5 and 6.

It can be understood that, since the first optical axis 450 does not coincide with the first rotation axis 4236, when the first rotor 4231 rotates at a high speed, the entire scanning assembly 40 is easily caused to shake and is not stable enough, thereby limiting rotation speed of the scanning assembly 40. To solve this technical problem, in some embodiments of the present disclosure, dynamic balance of the scanning assembly 40 is improved by reducing weight of the scanning assembly 40 and increasing weight of the scanning assembly 40.

For example, when the dynamic balance of the scanning assembly 40 is improved by reducing the weight of the scanning assembly 40, in some of the following embodiments, a notch is formed at the first lens 45 and/or the first rotor 4231 in order to improve the dynamic balance of the scanning assembly 40.

Position of the notch of the first lens 45 and the first rotor 4231 will be described below.

Referring to FIG. 2, in some embodiments, the notch includes a chamfer 455 opened at the first lens 45. The chamfer 455 is located at an edge position of the first lens 45, and the chamfer 455 is opposite to an inner surface of the side wall 4234 of the first rotor 4231 and is located at a position of the first lens 45 away from light path of the first lens 45, that is, the chamfer 455 is located at a position of the first lens 45 where the light does not pass. As such, the chamfer 455 can improve the dynamic balance of the scanning assembly 40 without affecting transmission of the laser in the first lens 45.

Referring to FIG. 2, in some embodiments, the first rotor 4231 includes a first end 4237a and a second end 4237b that are distributed along direction of the first rotation axis 4236 of the first rotor 4231, and the first end 4237a and the second end 4237b are arranged opposite to each other. The first end 4237a of the first rotor 4231 is close to the second surface 454 of the first lens 45, and the second end 4237b of the first rotor 4231 is close to the first surface 453 of the first lens 45. The notch includes an inner cutting groove 4234a formed at the inner surface of the side wall 4234 of the first rotor 4231, and the inner cutting groove 4234a is closer to the second end 4237b than the first end 4237a, that is, the inner cutting groove 4234a extends from the first end 4237a toward direction of the second end 4237b.

In some embodiments, number of the inner cutting grooves 4234a can be multiple (greater than or equal to two), and the multiple inner cutting grooves 4234a are arranged at intervals. As such, it can be avoided that a single inner cutting groove 4234a with a larger area has a greater impact on strength of the side wall 4234 of the first rotor 4231. In some embodiments, the inner cutting groove 4234a is opposite to the chamfer 455, and projection range (range or extent of the projection) of the inner cutting groove 4234a on the first rotation axis 4236 covers projection range of the chamfer 455 on the first rotation axis 4236.

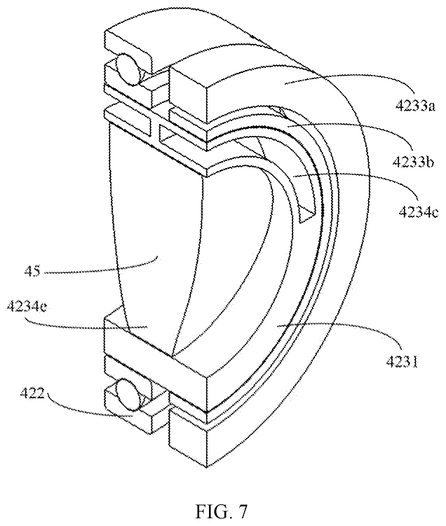

Referring to FIGS. 2 and 7, in some embodiments, the notch includes a groove 4234c formed in the middle (between the outer surface and the inner surface) of the side wall 4234 of the first rotor 4231, that is, the groove 4234c does not extend through the inner surface and the outer surfaces of the wall 4234. In some embodiments, number of the grooves 4234c can be multiple (greater than or equal to two), and the multiple grooves 4234c are arranged at intervals. As such, it can be avoided that a single groove 4234c with a larger area has a greater impact on the strength of the side wall 4234.

Referring to FIG. 2, in some embodiments, projection range of the groove 4234c on the first rotation axis 4236 covers the projection range of the chamfer 455 on the first rotation axis 4236. In some other embodiments, the projection range of the groove 4234c on the first rotation axis 4236 covers the projection range of the inner cutting groove 4234a on the first rotation axis 4236. In some other embodiments, the projection range of the groove 4234c on the first rotation axis 4236 covers both the projection ranges of the chamfer 455 and the inner cutting groove 4234a on the first rotation axis 4236.

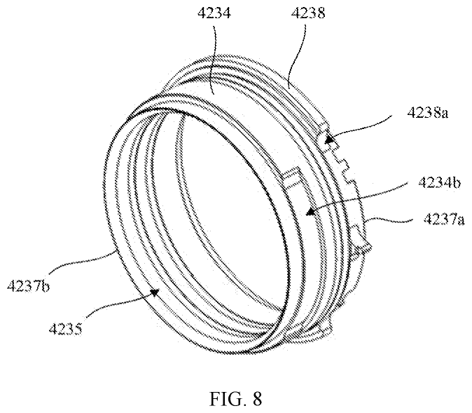

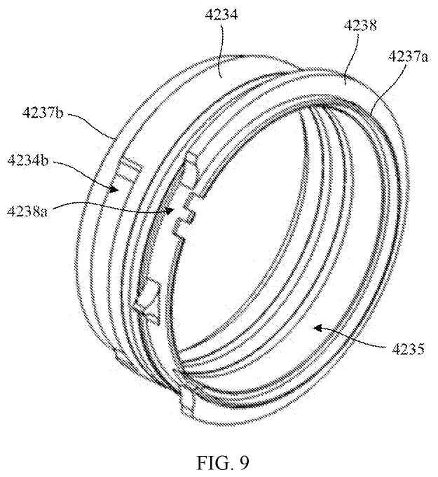

Referring to FIGS. 2, 8, and 9, in some embodiments, the first rotor 4231 includes the first end 4237a and the second end 4237b that are distributed along the direction of the first rotation axis 4236 of the first rotor 4231, and the first end 4237a and the second end 4237b are arranged opposite to each other. The first end 4237a of the first rotor 4231 is close to the second surface 454 of the first lens 45, and the second end 4237b of the first rotor 4231 is close to the first surface 453 of the first lens 45. The notch includes an outer cutting groove 4234b formed at the outer surface of the side wall 4234 of the first rotor 4231, and the outer cutting groove 4234b is closer to the first end 4237a than the second end 4237b, that is, the outer cutting groove 4234b extends from the second end 4237b toward direction of the first end 4237a. In some embodiments, number of the outer cutting grooves 4234b can be multiple (greater than or equal to two), and the multiple outer cutting grooves 4234b are arranged at intervals. As such, it can be avoided that a single outer cutting groove 4234b with a larger area has a greater impact on strength of the side wall 4234.

Referring to FIGS. 2, 8, and 9, in some embodiments, the first rotor 4231 includes the first end 4237a and the second end 4237b that are distributed along the direction of the first rotation axis 4236 of the first rotor 4231, and the first end 4237a and the second end 4237b are arranged opposite to each other. The first end 4237a of the first rotor 4231 is close to the second surface 454 of the first lens 45, and the second end 4237b of the first rotor 4231 is close to the first surface 453 of the first lens 45. A rib 4238 is formed at the outer surface of the side wall 4234 of the first rotor 4231 extending radially outward. The rib 4238 is arranged around the side wall 4234 of the first rotor 4231, and the rib 4238 is closer to the second end 4237b than the first end 4237a. The notch includes an opening 4238a opened at the rib 4238. In some embodiments, number of the openings 4238a can be multiple (greater than or equal to two), and the multiple openings 4238a are arranged at intervals. As such, a greater impact on strength of the rib 4238 by a single opening 4238a with a larger area can be avoided.

In some embodiments, the notch (the chamfer 455, the inner cutting groove 4234a, the outer cutting groove 4234b, the groove 4234c, and the opening 4238a) may be symmetrical about a first plane that passes through the first optical axis 450 and the first rotation axis 4236, that is, the first plane coincides with the cross section shown in FIG. 2.

As such, arrangement of the notch described above is conducive to reducing shaking caused by the first optical axis 450 of the first lens 45 being non-coincident with the first rotation axis 4236 of the first rotor 4231 when the first lens 45 rotates, and is conducive to the entire first rotor 4231 to be more stable during rotation.

Referring to FIG. 3, it can be understood that the position of the notch described above is a position where the light path does not pass, which does not affect propagation of the light beam, and does not reduce light emission and light reception efficiency of the first lens 45.

When the first lens 45 is a complete revolution body, the dynamic balance of the scanning assembly 40 can be improved by increasing the weight of the scanning assembly 40. In some of the following embodiments, a boss 4232 is added to the first rotor 4231 in order to improve the dynamic balance of the scanning assembly 40.

Referring to FIG. 10, position of the first rotor 4231 and the boss 4232 will be described below.

The first driver 42 also includes the boss 4232 configured to improve stability of the first rotor 4231 during rotation. Specifically, the boss 4232 is arranged at the side wall 4234 of the first rotor 4231 and is located within the first receiving cavity 4235, The boss 4232 extends from the side wall 4234 toward center of the first receiving cavity 4235, and height of the boss 4232 extending toward the center of the first receiving cavity 4235 may be lower than a predetermined ratio of radial width of the first receiving cavity 4235. The predetermined ratio may be 0.1, 0.22, 0.3, 0.33, etc., so as to prevent the boss 4232 from blocking the first receiving cavity 4235 too much and affecting transmission light path of the laser pulse.

The boss 4232 can be fixedly connected to the first rotor 4231, so that the boss 4232 and the first rotor 4231 can rotate synchronously. The boss 4232 may be integrally formed with the first rotor 4231, for example, integrally formed by a process such as injection molding. The boss 4232 may also be formed separately from the first rotor 4231, and the boss 4232 is fixed at the side wall 4234 of the first rotor 4231 after the boss 4232 and the first rotor 4231 are formed separately. For example, the boss 4232 is glued to the side wall 4234 of the first rotor 4231, or the boss 4232 is fixed to the side wall 4234 of the first rotor 4231 by a fastener such as a screw, where surface of the boss 4232 attached to the side wall 4234 is a curved surface. In some embodiments, the boss 4232 rotates synchronously with the first yoke 4233a, and the boss 4232 is fixedly connected to the first yoke 4233a.

Referring to FIG. 10, in some embodiments, when the boss 4232 is mounted within the first receiving cavity 4235, the boss 4232 and the first lens 45 are distributed along radial direction of the first rotor 4231. In this case, one end of the first lens 45 can be in contact with the inner surface of the side wall 4234, the other end 452 forms a gap with the side wall 4234, and the boss 4232 extends into the gap. As such, when the first lens 45 and the first rotor 4231 rotate together, an overall rotation formed by the first lens 45 and the boss 4232 is stable, so that the first rotor 4231 is prevented from shaking, and the entire first rotor 4231 is more stable during rotation.

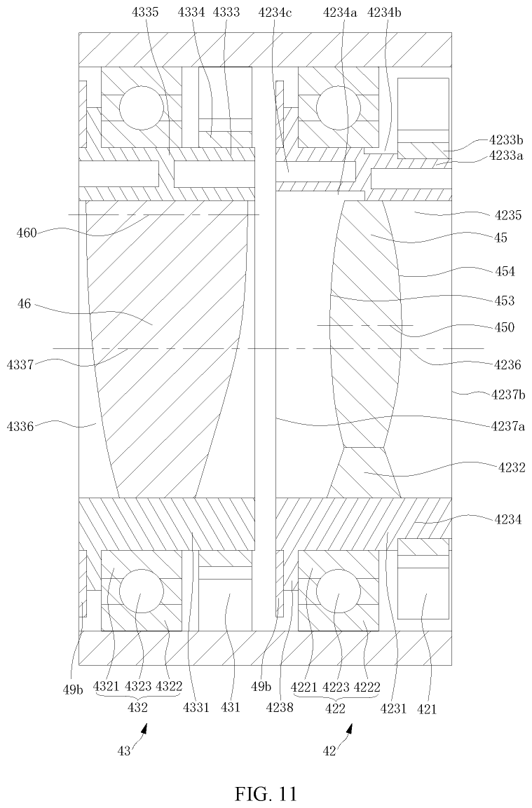

Referring to FIG. 11, in some embodiments, projection range of the boss 4232 on the first rotation axis 4236 covers projection range of the first lens 45 on the first rotation axis 4236. In some other embodiments, size of the boss 4232 along the first optical axis 450 is greater than size of the first lens 45 on the cross section of the scanning assembly 40 taken by the first plane, where the first plane is a plane passing through the first optical axis 450 and the first rotation axis 4236, that is, the first plane coincides with the cross section shown in FIG. 11.

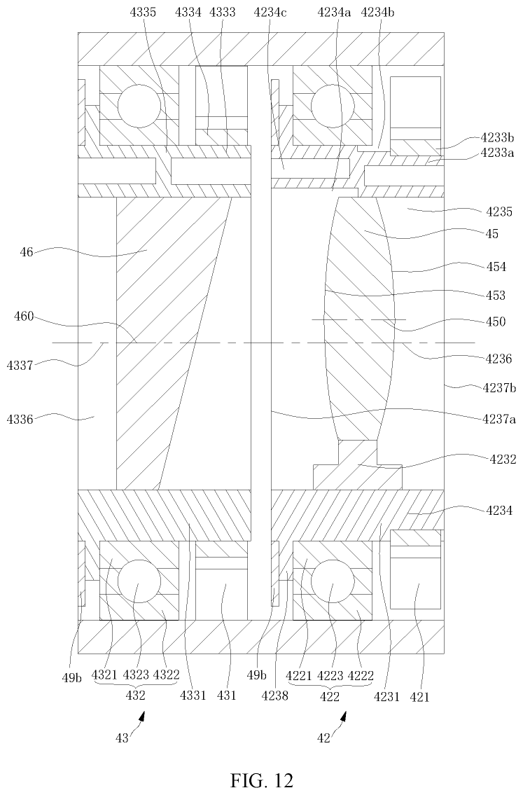

In some embodiments, on the cross section of the scanning assembly 40 taken by the first plane, the boss 4232 has a left-right symmetrical shape, where the first plane is a plane passing through the first optical axis 450 and the first rotation axis 4236, as shown in FIGS. 10-12. In some embodiments, the left-right symmetrical shape is a trapezoid, where size of one side of the boss 4232 interfacing with the inner surface of the side wall 4234 of the first rotor 4231 is greater than size of one side of the boss 4232 away from the inner surface of the side wall 4234 of the first rotor 4231, as shown in FIG. 11. In some other embodiments, the left-right symmetrical shape is a “convex” shape, where the size of one side of the boss 4232 interfacing with the inner surface of the side wall 4234 of the first rotor 4231 is greater than the size of one side of the boss 4232 away from the inner surface of the side wall 4234 of the first rotor 4231, as shown in FIG. 12.

In some embodiments, density of the boss 4232 is greater than density of the first rotor 4231, so that when the boss 4232 is arranged within the first receiving cavity 4235, volume of the boss 4232 can be set to be relatively smaller with the same mass, so as to reduce effect of the boss 4232 on the laser pulse passing through the first receiving cavity 4235. In some embodiments, the density of the boss 4232 can be greater than density of the first lens 45, so that the volume of the same boss 4232 can be designed as small as possible.

As such, arrangement of the boss 4232 described above is conducive to reducing shaking caused by the first optical axis 450 of the first lens 45 being non-coincident with the first rotation axis 4236 of the first rotor 4231 when the first lens 45 rotates, and is conducive to the entire first rotor 4231 to be more stable during rotation.

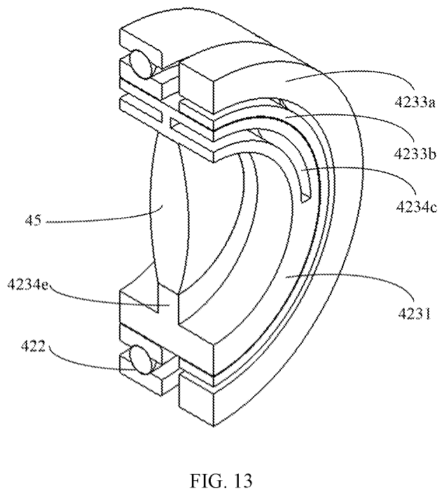

Referring to FIGS. 2 and 13, in some embodiments, when the first lens 45 is a complete revolution body, the first driver 42 may not include the boss 4232. The inner surface of the side wall 4234 of the first rotor 4231 is formed with a first support, and the first support includes a convex ring 4234e extending from the side wall 4234 of the first rotor 4231 into the first receiving cavity 4235. Side wall of the first lens 45 abuts against the convex ring 4234e, and the first lens 45 can be combined with the first support to be mounted within the first receiving cavity 4235.

Referring to FIG. 2, the second driver 43 includes a second stator 431, a second positioning bearing 432, and a second rotor 4331. The second stator 431 may be fixed relative to the scanner housing 41, and the second stator 431 may be configured to drive the second rotor 4331 to rotate. The second stator 431 includes a second winding body and a second winding mounted at the second winding body, where the second winding body may be a stator core, and the second winding may be a coil. The second winding can generate a specific magnetic field under action of current, and direction and intensity of the magnetic field can be changed by changing direction and intensity of the current. The second stator 431 is sleeved on the second rotor 4331.

The second rotor 4331 may be driven by the second stator 431 to rotate. Specifically, an axis about which the second rotor 4331 rotates relative to the second stator 431 is referred to as a second rotation axis 4337. It can be understood that the second rotation axis 4337 can be a physical rotation axis or a virtual rotation axis. The second rotor 4331 includes a second yoke 4333 and a second magnet 4334, and the second magnet 4334 is sleeved on the second yoke 4333 and is located between the second yoke 4333 and the second winding. Magnetic field generated by the second magnet 4334 interacts with the magnetic field generated by the second winding and generates a force. Since the second winding is fixed, the second magnet 4334 drives the second yoke 4333 to rotate under the force. The second rotor 4331 has a hollow shape. A hollow portion of the second rotor 4331 is formed with a second receiving cavity 4336, and the laser pulse can pass through the second receiving cavity 4336 and pass through the scanning assembly 40. Specifically, the second receiving cavity 4336 is surrounded by a side wall 4335 of the second rotor 4331. More specifically, in some embodiments, the second yoke 4333 may have a hollow cylindrical shape, and a hollow portion of the second yoke 4333 is formed with the second receiving cavity 4336, and a side wall of the second yoke 4333 can be used as a side wall enclosing the second receiving cavity 4336. Of course, in some other embodiments, the second receiving cavity 4336 may not be formed at the second yoke 4333, but at a structure such as the second magnet 4334, and the side wall 4335 may also be a side wall of a structure such as the second magnet 4334, which are not limited herein. The side wall 4335 has a ring structure or is a part of a ring structure. The second winding of the second stator 431 may have a ring shape and surround an outer surface of the second rotor 4331.

The second positioning bearing 432 is arranged at the second rotor 4331 and is located at one side of the second stator 431 away from the first rotor 4231. The second positioning bearing 432 is configured to restrict the second rotor 4331 to rotate around the fixed second rotation shaft 4337. The second positioning bearing 432 and the second stator 431 surround the outer surface of the side wall 4335 of the second rotor 4331 side by side. The second bearing 432 includes a second inner ring structure 4321, a second outer ring structure 4322, and a second rolling body 4323. The second inner ring structure 4321 and the outer surface of the side wall 4335 of the second rotor 4331 are fixed to each other, and the second outer ring structure 4322 and the scanner housing 41 are fixed to each other. The second rolling body 4323 is located between the second inner ring structure 4321 and the second outer ring structure 4322, and the second rolling body 4323 is configured to rolling connect with the second outer ring structure 4322 and the second inner ring structure 4321, respectively.

The light refraction element 46 is mounted within the second receiving cavity 4336 and is located on the emission and incident light path of the laser pulse. The second optical axis 460 of the light refraction element 46 is parallel to and spaced apart from the second rotation axis 4337 of the second rotor 4331, and the light refraction element 46 and the second rotor 4331 can rotate around the second rotation axis 4337 synchronously. When the light refraction element 46 rotates, the transmission direction of the laser passing through the light refraction element 46 can be changed. As such, the light refraction element 46 can achieve the effect of deflecting the laser while collimating the laser, which can reduce the number of arranged prisms. That is, the number of parts of the scanning assembly 40 and the size of the scanning assembly 40 can be reduced.

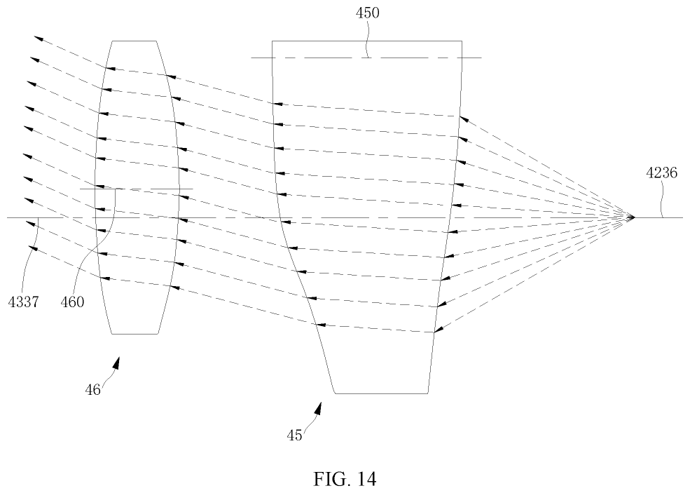

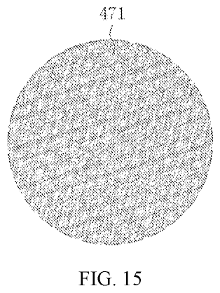

It can be understood that, since the first optical axis 450 of the first lens 45 does not coincide with the first rotation axis 4236 of the first rotor 4231, and the second optical axis 460 of the light refraction element 46 does not coincide with the second rotation axis 4237 of the second rotor 4331, when the first rotor 4231 and the second rotor 4331 rotate at high speed, laser spots irradiated on the first lens 45 and emitted by the light refraction element 46 form an irregular scanning range 471, and the scanning range 471 of the laser spots is spread over a certain range of areas, as shown in FIGS. 14 and 15. As such, it is conducive to expanding detection range of the scanning assembly 40 to detect the to-be-detected object. It can be understood that the scanning range 471 shown in FIG. 15 is circular as an example, and shape of the scanning range 471 is not limited.

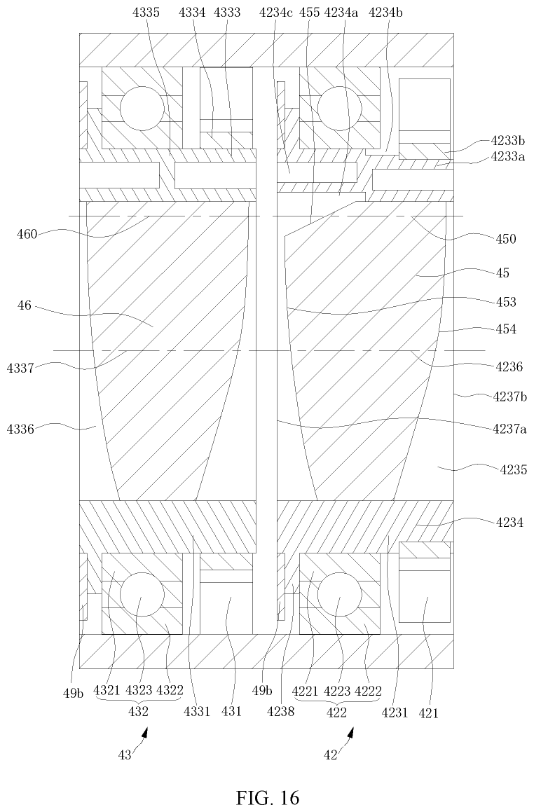

The light refraction element 46 may be any one of a lens, a reflector, a prism, a galvanometer, a grating, a liquid crystal, an optical phased array. In some embodiments, the light refraction element 46 may be a complete revolution body formed with the second optical axis 460 as the center of rotation, as shown in FIGS. 2 and 10. In some other embodiments, the light refraction element 46 may also be a part of a revolution body formed with the second optical axis 460 as the center of rotation, as shown in FIGS. 11 and 16. It can be understood that whether the light refraction element 46 is a complete revolution body can be set according to the size of the diaphragm. For example, when the radial size of the diaphragm is smaller than radial size of the light refraction element 46, the light refraction element 46 may be an incomplete revolution body; when the radial size of the diaphragm is greater than the radial size of the light refraction element 46, the light refraction element 46 may be a complete revolution body, so that the light refraction element 46 can adapt to diaphragms of different sizes.

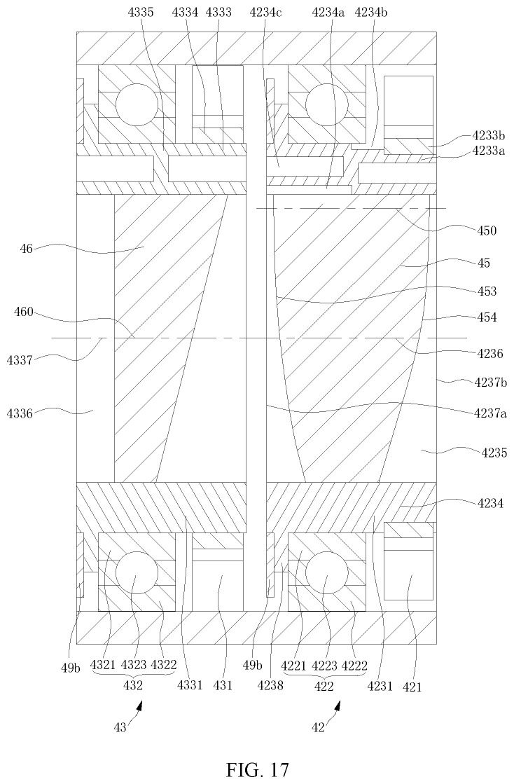

It should be noted that the first lens 45 and the light refraction element 46 can be combined in various manners. For example, the first lens 45 is a part of a revolution body formed with the first optical axis 450 as the center of rotation, and the light refraction element 46 is a lens that is a complete revolution body formed with the second optical axis 460 as the center of rotation, as shown in FIG. 2; or, the first lens 45 is a part of a revolution body formed with the first optical axis 450 as the center of rotation, and the light refraction element 46 is a lens that is a part of a revolution body formed with the second optical axis 460 as the center of rotation, as shown in FIG. 16; or, the first lens 45 is a part of a revolution body formed with the first optical axis 450 as the center of rotation, and the light refraction element 46 is a prism, as shown in FIG. 17; or, the first lens 45 is a complete revolution body formed with the first optical axis 450 as the center of rotation, and the light refraction element 46 is a lens that is a complete revolution body formed with the second optical axis 460 as the center of rotation, as shown in FIG. 10; or, the first lens 45 is a complete revolution body formed with the first optical axis 450 as the center of rotation, and the light refraction element 46 is a lens that is part of a complete revolution body formed with the second optical axis 460 as the center of rotation, as shown in FIG. 11; or, the first lens 45 is a complete revolution body formed with the first optical axis 450 as the center of rotation, and the light refraction element 46 is a prism, as shown in FIG. 12.

When the light refraction element 46 is a convex lens, the light refraction element 46 can perform secondary collimation on the laser, so that surface curvature of the first lens 45 can be prevented from being too large, and manufacturing difficulty of the first lens 45 can be reduced. When the light refraction element 46 is a prism, the light refraction element 46 has non-parallel light emission surface and light incident surface. As such, when the light refraction element 46 rotates, the light beam can be refracted to different directions to emit, which can enhance the effect of deflecting laser of the scanning assembly 40, and so the second optical axis 460 of the light refraction element 46 coincides with the second rotation axis 4337 in this case.

It can be understood that, since the second optical axis 460 of the light refraction element 46 does not coincide with the second rotation axis 4337 of the second rotor 4331, when the second rotor 4331 rotates at a high speed, the entire scanning assembly 40 is easily caused to shake and is not stable enough, thereby limiting rotation speed of the scanning assembly 40. To solve this technical problem, in some embodiments of the present disclosure, the dynamic balance of the scanning assembly 40 is improved by reducing the weight of the scanning assembly 40 and increasing the weight of the scanning assembly 40. For example, when the dynamic balance of the scanning assembly 40 is improved by reducing the weight of the scanning assembly 40, a notch can be formed at the light refraction element 46 and/or the second rotor 4331 in order to improve the dynamic balance of the scanning assembly 40. When the dynamic balance of the scanning assembly 40 is improved by increasing the weight of the scanning assembly 40, a boss can be added to the second rotor 4331 in order to improve the dynamic balance of the scanning assembly 40. It can be understood that, for the specific structures and arrangements of the notch and the boss, reference can be made to the aforementioned description of the first lens 45 and the first rotor 4231, which will not be repeated herein.

Referring to FIG. 2, in some embodiments, the second driver 43 may not be provided with the boss. An inner surface of the side wall 4335 of the second rotor 4331 is formed with a second support, and the second support includes a second convex ring 466 extending from the side wall 4335 of the second rotor 4331 into the second receiving cavity 4336. Side wall of the light refraction element 46 abuts against the second convex ring 466, and the light refraction element 46 can be combined with the second convex ring 466 to be mounted within the second receiving cavity 4336.

In some embodiments, at least some optical elements (the first lens 45 and the light refraction element 46) are movable. For example, the at least some optical elements are driven to move by the drivers (the first driver 42 and the second driver 43), and the moving optical elements can reflect, refract, or diffract the light beam to different directions at different times.

In some embodiments, the optical elements (the first lens 45 and the light refraction element 46) of the scanning assembly 40 can rotate or vibrate around a common axis, and each rotating or vibrating optical element is configured to constantly change propagation direction of the incident light beam. The optical elements of the scanning assembly 40 can rotate at different rotation speeds or vibrate at different speeds. Or, at least some optical elements of the scanning assembly 40 can rotate at substantially the same rotation speed.

In some embodiments, the optical elements (the first lens 45 and the light refraction element 46) of the scanning assembly can also rotate around different axes. The optical elements of the scanning assembly 40 can also rotate in the same direction or in different directions; or vibrate in the same direction or in different directions, which are not limited herein.

Referring to FIGS. 2 and 18, the controller 49a is connected to the drivers (the first driver 42 and the second driver 43), and the controller 49a is configured to control the drivers to drive the optical elements (the first lens 45 and the light refraction element 46) to rotate according to control command. Specifically, the controller can be connected to the windings (the first winding and the second winding) and configured to control magnitude and direction of the current of the windings to control rotation parameters (rotation direction, rotation angle, rotation duration, etc.), so that purpose of controlling the rotation parameters of the optical elements can be achieved. In some embodiments, the controller 49a includes an electronic speed controller, and the controller 49a may be provided on an electronic control board.

The detector 49b is configured to detect the rotation parameters of the optical elements (the first lens 45 and the light refraction element 46), and the rotation parameter of the optical elements may be the rotation direction, the rotation angle, the rotation speed, etc. of the optical elements. Number of the detectors 49b can be multiple, and each detector 49b includes a code disc and a photoelectric switch. The code disc is fixedly connected to a rotor (the first rotor 4231 or the second rotor 4331) and rotates synchronously. It can be understood that since the optical element rotates synchronously with the rotor, the code disc rotates synchronously with the optical element, so that the rotation parameters of the optical element can be obtained by detecting rotation parameters of the code disc. Specifically, the rotation parameters of the code disc can be detected through cooperation of the code disc and the photoelectric switch.

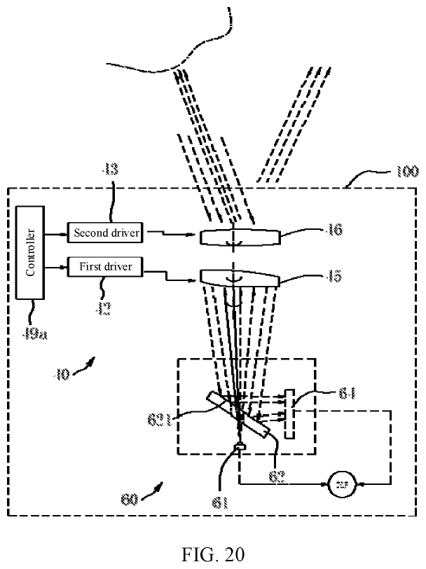

Referring to FIGS. 18 and 20, the ranging assembly 60 includes the light source 61, the light path changing element 62, and a detector 64. A coaxial light path can be used in the ranging assembly 60, that is, laser beam emitted by the ranging assembly 60 and reflected laser beam share at least part of the light path within the ranging assembly 60. An off-axis light path can also be used in the ranging assembly 60, that is, light beam emitted by the ranging assembly 60 and reflected light beam are respectively transmitted along different light paths within the ranging assembly 60.

Referring to FIG. 18, the light source 61, the light path changing element 62, and the detector 64 are described below in a case where a coaxial light path is used in the ranging assembly 60.

The light source 61 may be configured to emit a light pulse sequence. For example, light beam emitted by the light source 61 is a narrow-bandwidth light beam with a wavelength outside visible light range. In some embodiments, the light source 61 may include a laser diode, and the laser diode emits nanosecond level laser. For example, a laser pulse emitted by the light source 61 lasts for 10 ns.

The light path changing element 62 is arranged on emission light path of the light source 61 and is configured to combine the emission light path of the light source 61 and reception light path of the detector 64. Specifically, the light path changing element 62 is located at an opposite side of the scanning assembly 40. The light path changing element 62 may be a reflector or a half reflector. In some embodiments, the light path changing element 62 is a small reflector, which can change light path direction of laser beam emitted by the light source 61 by 90 degrees or another angle.

The detector 64 is arranged at one side of the light path changing element 62. It can be understood that the scanning assembly 40 can change the light pulse sequence to different transmission directions at different times to emit, and light pulse reflected by the to-be-detected object can be incident to the detector 64 after passing through the scanning assembly 40. The detector 64 can be configured to convert at least part of the reflected light into an electrical signal, and the electrical signal may specifically be an electrical pulse. The detector 64 can also determine the distance between the to-be-detected object and the ranging device 100 (as shown in FIG. 21) based on the electrical pulse.

When the ranging device 100 is operating, the light source 61 emits the laser pulse, and after passing through the light path changing element 62 and then being changed the transmission direction by the scanning assembly 40, the laser pulse is emitted and projected onto the to-be-detected object. At least part of the reflected light of the laser pulse reflected by the to-be-detected object after passing through the scanning assembly 40 is converged to the detector 64, and the detector 64 converts at least part of the reflected light into an electrical signal pulse.

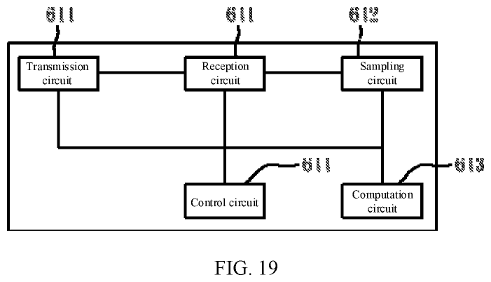

Referring to FIGS. 18 and 19, the ranging device 100 (as shown in FIG. 21) of the present disclosure includes a transmission circuit 611, a reception circuit 641, a sampling circuit 642, and a computation circuit 643. The transmission circuit 611 can emit the light pulse sequence (e.g., a laser pulse sequence). The reception circuit 641 can receive the light pulse sequence reflected by the to-be-detected object and perform photoelectric conversion on the light pulse sequence to obtain the electrical signal, and then the electrical signal is processed and output to the sampling circuit 642. The sampling circuit 642 can sample the electrical signal to obtain a sampling result. The computation circuit 643 can determine the distance between the ranging device 100 and the to-be-detected object based on the sampling result of the sampling circuit 642. In some embodiments, the transmission circuit 611 includes the light source 61, and the detector 64 includes the reception circuit 641, the sampling circuit 642, and the computation circuit 643.

For example, the ranging device 100 may also include a control circuit 644, which can control other circuits, for example, can control operation time of each circuit and/or set parameters for each circuit. In this case, the detector 64 may also include the control circuit 644.

It should be noted that although the ranging device 100 shown in FIG. 19 includes a transmission circuit 611, a reception circuit 641, a sampling circuit 642, and a computation circuit 643, the embodiments of the present disclosure are not limited thereto. Number of any one of the transmission circuit 611, the reception circuit 641, the sampling circuit 642, and the computation circuit 643 may also be at least two, which are configured to emit at least two light beams in same direction or in different directions. The at least two light beams may be emitted simultaneous or may be emitted at different times. In some embodiments, light emitting chips in the at least two transmission circuits are packaged in same module. For example, each transmission circuit includes a laser emitting chip, and the laser emitting chips in the at least two transmission circuits are packaged together and housed in same package space.

Referring to FIG. 20, the light source 61, the light path changing element 62, and the detector 64 are described below in a case where a second coaxial light path is used in the ranging assembly 60. In this case, the light path changing element 62 is a large reflector. The large reflector includes a reflective surface 621, and a light through hole is opened in middle position of the large reflector. Compared with the first coaxial light path described above, positions of the detector 64 and the light source 61 are interchanged, and the detector 64 is opposite to the reflective surface 621.

When the ranging device 100 is operating, the light source 61 emits the laser pulse, and after passing through the light through hole of the light path changing element 62 and then being changed the transmission direction by the scanning assembly 40, the laser pulse is emitted and projected onto the to-be-detected object. At least part of the reflected light of the laser pulse reflected by the to-be-detected object after passing through the scanning assembly 40 is converged to the reflective surface 621 of the light path changing element 62. The reflective surface 621 reflects the at least part of the reflected light to the detector 64, and the detector 64 converts the at least part of the reflected light into the electrical signal pulse. The ranging device 100 determines laser pulse reception time according to rising edge time and/or falling edge time of the electrical signal pulse. As such, the ranging device 100 can use pulse reception time information and pulse sending time information to calculate flight time, so as to determine the distance from the to-be-detected object to the ranging device 100. In some embodiments, size of the light path changing element 62 is relatively large, which can cover the entire field of view of the light source 61. The reflected light is directly reflected by the light path changing element 62 to the detector 64, which avoids blocking of the reflected light path by the light path changing element 62 itself, increases intensity of the reflected light that the detector 64 can detect, and improves accuracy of ranging.

Referring to FIG. 2, in some embodiments, the scanning assembly 40 includes a plurality of second drivers 43 and a plurality of light refraction elements 46. Each light refraction element 46 is mounted at a corresponding second driver 43, and each second driver 43 is configured to drive a corresponding light refraction element 46 to rotate. Each second driver 43 and each light refraction element 46 can be the second driver 43 and the light refraction element 46 in any of the foregoing embodiments, and will not be described in detail herein. The “plurality” in this specification refers to at least two or more. After direction of the laser beam is changed by one light refraction element 46, the direction can be changed again by another light refraction element 46, so as to increase the ability of the scanning assembly 40 to entirely change the propagation direction of the laser in order to scan a larger spatial range. Also, by setting different rotation directions and/or rotation speeds of the second driver 43, the laser beam can scan a predetermined scanning shape. In addition, each second driver 43 includes the boss and/or the second support, and each boss and/or second support is fixed at the inner surface of the side wall of the corresponding rotor to improve the dynamic balance of the rotor during rotation.

The second rotation axes 4337 of the plurality of second rotors 4331 may be the same, and the plurality of light refraction elements 46 all rotate around the same second rotation axis 4337; the second rotation axes 4337 of the plurality of second rotors 4331 may also be different, and the plurality of light refraction elements 46 rotate around the different second rotation axes 4337. In some other embodiments, the plurality of light refraction elements 46 can also vibrate in the same direction or in different directions, which is not limited herein.

Referring to FIG. 21, the embodiments of the present disclosure also provide a mobile platform 1000, and the mobile platform 1000 includes a mobile platform body 200 and the ranging device 100 of any one of the foregoing embodiments. The mobile platform 1000 may be a mobile platform such as an unmanned aerial vehicle, an unmanned vehicle, an unmanned ship, etc. One mobile platform 1000 may be configured with one or more ranging devices 100, and the ranging device 100 can be configured to detect surrounding environment around the mobile platform 1000, so that the mobile platform 1000 can further perform operations such as obstacle avoidance and trajectory selection based on the surrounding environment.

In the description of this specification, the description with reference to the terms “certain embodiments,” “an embodiment,” “some embodiments,” “exemplary embodiments,” “examples,” “specific examples,” or “some examples,” etc., means that combinations of the specific features, structures, materials, or characteristics described by the embodiments or the examples may be included in at least one embodiment or example of the present disclosure. In this specification, the schematic representations of the above terms do not necessarily refer to the same embodiment or example. Moreover, the described specific features, structures, materials, or characteristics can be combined in an appropriate manner in any one or more embodiments or examples.

In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present disclosure, “multiple” means at least two, such as two, three, etc., unless otherwise specifically defined.

Although the embodiments of the present disclosure have been shown and described above, it can be understood that the embodiments described above are exemplary and should not be construed as limitations to the present disclosure. Those of ordinary skill in the art can make changes, modifications, substitutions, and variants to the embodiments described above within the scope of the present disclosure.

What is claimed is:

1. A scanning assembly comprising:
a driver; and
a lens mounted at the driver and configured to collimate a light beam incident from one side of the lens;
wherein the driver is configured to drive the lens to rotate around a rotation axis that is spaced apart from an optical axis of the lens.

2. The scanning assembly of claim 1, wherein:
the optical axis is parallel to the rotation axis; or
the optical axis rotates around the rotation axis.

3. The scanning assembly of claim 1, wherein the driver includes:
a stator; and
a rotor configured to rotate relative to the stator to drive the lens to rotate around the rotation axis and including a receiving cavity, the lens being mounted within the receiving cavity.

4. The scanning assembly of claim 3, wherein the driver further includes a positioning bearing fixedly connected to the stator and rotatably connected to the rotor and configured to restrict a rotation of the rotor around the rotation axis relative to the first stator.

5. The scanning assembly of claim 3, wherein the lens is a complete revolution body formed with the optical axis as a rotation center.

6. The scanning assembly of claim 5, wherein an inner surface of a side wall of the rotor is formed with a support, and the lens is combined with the support to be mounted within the receiving cavity.

7. The scanning assembly of claim 6, wherein the support includes a convex ring extending from the side wall of the rotor into the receiving cavity, and a side wall of the lens abuts against the convex ring.

8. The scanning assembly of claim 3, wherein the lens is a part of a revolution body formed with the optical axis as a rotation center.

9. The scanning assembly of claim 3, wherein the driver further includes a boss arranged at a side wall of the rotor and located within the receiving cavity, the boss and the optical axis being located on opposite sides of the rotation axis.

10. The scanning assembly of claim 3, wherein a notch is formed at the rotor or the lens, the notch and the optical axis being located on a same side of the rotation axis.

11. The scanning assembly of claim 10, wherein the notch includes at least one of:
a chamfer formed at the lens;
an inner cutting groove formed at an inner surface of a side wall of the rotor;
a middle cutting groove formed at the side wall of the rotor, the middle cutting groove being located between the inner surface and an outer surface of the side wall of the rotor;
an outer cutting groove formed at the outer surface of the side wall of the rotor; or
an opening opened at a convex rib formed at the outer surface of the side wall of the rotor, the convex rib extending outward in a radial direction and being arranged around the side wall of the rotor.

12. The scanning assembly of claim 1,
wherein the driver is a first driver and the rotation axis is a first rotation axis;
the scanning assembly further comprising:
a second driver; and
a light refraction element mounted at the second driver and configured to change a transmission direction of an incident light beam from the lens;
wherein the second driver is configured to drive the light refraction element to rotate around a second rotation axis.

13. The scanning assembly of claim 12, wherein the second driver includes:
a stator; and
a rotor configured to rotate relative to the stator to drive the light refraction element to rotate around the second rotation axis and including a receiving cavity, the light refraction element being mounted within the receiving cavity.

14. The scanning assembly of claim 13, wherein:
the lens is a first lens and the optical axis is a first optical axis;
the light refraction element includes a second lens;
the second lens and the first lens form a beam collimation system configured to collimate the incident light beam; and
a second optical axis of the second lens is spaced apart from the second rotation axis.

15. The scanning assembly of claim 14, wherein the second lens is a complete revolution body formed with the second optical axis as rotation center.

16. The scanning assembly of claim 14, wherein an inner surface of a side wall of the rotor is formed with a support, and the second lens is combined with the support to be mounted within the receiving cavity.

17. The scanning assembly of claim 16, wherein the support includes a convex ring extending from the side wall of the rotor into the receiving cavity, and a side wall of the second lens abuts against the convex ring.

18. The scanning assembly of claim 14, wherein the second lens is a part of a revolution body formed with the second optical axis as rotation center.

19. The scanning assembly of claim 13, wherein the light refraction element includes a prism including a pair of opposite non-parallel surfaces.

20. A ranging device comprising:
a scanning assembly including:
a driver; and
a lens mounted at the driver and configured to collimate a light beam incident from one side of the lens;
wherein the driver is configured to drive the lens to rotate around a rotation axis that is spaced apart from an optical axis of the lens; and
a ranging assembly including a light source configured to emit a laser pulse sequence, a central axis of a light beam emitted by the light source being spaced apart from the optical axis.
